(19) United States
(12) Patent Application Publication
(10) Pub. No.: US 2026/0221772 A1
(43) Pub. Date: Jul. 30, 2026

(54) SLCC COMMUTATION SYSTEM FOR NOVEL ELECTRIC POWER SYSTEM, METHOD FOR CONTROLLING SLCC COMMUTATION SYSTEM, STORAGE MEDIUM, AND PROGRAM PRODUCT

(71) Applicant: State Grid Economic and technological Research Institute Co., Ltd, Beijing (CN)

(72) Inventors: Weimin MA, Beijing (CN); Yong HUANG, Beijing (CN); Ling WANG, Beijing (CN); Ming Li, Beijing (CN); Fangjie WU, Beijing (CN); Ying XU, Beijing (CN); Xiaolin SHEN, Beijing (CN); Yinglin XUE, Beijing (CN); Tao ZHANG, Beijing (CN); Yiming JI, Beijing (CN); Jian YIN, Beijing (CN); Ziyu GUO, Beijing (CN); Caowei HUANG, Beijing (CN); ShaoweI WANG, Beijing (CN)

(21) Appl. No.: 18/880,304

(22) PCT Filed: Aug. 15, 2023
(86) PCT No.: PCT/CN2023/113185

§ 371 Date: Dec. 31, 2024

(30) Foreign Application Priority Data
Aug. 17, 2022 (CN) 202210984486.1

(51) Int. Cl. H02J 3/01; H02J 3/0014; H02J 3/1864; H02J 3/36; H02J 3/38

(52) U.S. Cl. CPC H02J 3/01; H02J 3/00142; H02J 3/1864; H02J 3/36; H02J 3/38; H02J 2003/365

(57) ABSTRACT

The present disclosure relates to the technical field of electric power transmission systems, and relates to an SLCC commutation system for a novel electric power system, and a method for controlling the SLCC commutation system. The SLCC commutation system for a novel electric power system comprises: a converter transformer for providing an alternating-current voltage and a converter unit for alternating-current and direct-current conversion. The converter transformer is connected in series to each phase in the converter unit by means of an inductor, each phase comprises an upper bridge arm and a lower bridge arm, each bridge arm comprises a VSC valve, an SVG branch is connected between the converter transformer and the converter unit, and the SVG branch is connected in parallel to an LCC converter valve; the SVG branch comprises a converter transformer and a reactor that are connected in series, and the output end of the reactor is connected to the converter transformer and the converter unit. The problems in conventional LCC direct-current power transmission technology of high dependence on an alternating current system and poor adaptability in a large-scale new energy pooling scene are solved, overvoltage of a transmitting end and undervoltage of a receiving end can be effectively suppressed, and the risk of commutation failure is reduced.

### CROSS-REFERENCE TO RELATED APPLICATION

This application is filed based on and claims priority to Chinese Patent Application No. 202210984486.1 filed on Aug. 17, 2022 and entitled “SLCC COMMUTATION SYSTEM FOR NEW POWER SYSTEM, AND METHOD FOR CONTROLLING SLCC COMMUTATION SYSTEM”, the disclosure of which is hereby incorporated by reference in its entirety.

### TECHNICAL FIELD

The disclosure relates to a Statcom and Line Commutation Converter (SLCC) commutation system for a new power system, a method for controlling the SLCC commutation system, a storage medium and a program product, and belongs to the technical field of power transmission systems.

### BACKGROUND

The new power system is a power system which takes inherent requirements of bearing and achieving peak carbon dioxide emissions and carbon neutrality, implementing a new development concept, building a new development pattern, and promoting high-quality development as a prerequisite, takes ensuring energy and power security as a basic premise, takes meeting power demand for economic and social development as a primary target, takes maximizing consumption and absorption of renewable energy as a main task, takes a strong smart grid as a hub platform, takes load-storage interaction between source and grid and multi-energy complementation as support, and has basic characteristics of being clean and low-carbon, safe and controllable, smart and friendly, open and interactive.

Direct Current (DC) transmission is a backbone energy transmission channel in China and will play an irreplaceable role in energy transmission. With respect to problems of grid connection, transmission, consumption, absorption or the like of large-scale clean energy, the DC transmission will be an essential means for further improving utilization rate of the clean energy, fully meeting future power demand, and helping construction of the new power system. Construction of the new power system is inseparable from the DC transmission, while it will also have a profound impact on the development of the DC transmission. The new power system may effectively promote integrated development of wind energy, solar energy, thermal power and energy storage at a DC transmission side, and increase a proportion of clean electricity in the transmission channel by taking comprehensive measures such as increasing a peak regulation depth of thermal power, configuring energy storage, and optimizing a DC curve, etc.

Conventional design concepts believe that with the development of power systems, strengths of the systems continuously increase, and the DC transmission has increasingly improved performance and stability. However, with the introduction of large-scale renewable energy, the following problems occur: (1) voltage fluctuation caused by switching of a filter is increasing, and switching frequently occurs; (2) a transformer frequently regulates voltage with load; (3) when a DC transmission system is disturbed, overvoltage of a grid at a sending side has an uptrend, threatening operation of wind turbines; (4) when the DC transmission system is disturbed, voltage at a receiving side has a recovery trend, threatening voltage stability; (5) background harmonics are amplified; (6) it is difficult to effectively solve oscillation problem of a Voltage Source Converter (VSC); (7) requirements on control technologies increase; (8) as the project scale increases, a converter station occupies a large area, etc.

The new power system has put forward increasing requirements on a high-voltage DC transmission. For example, randomness and volatility of wind power and photovoltaic power generation cause uncertainty of output at a power supply side. A system inertia provided by wind turbines is much smaller than that provided by thermal power units. In the new power system, once active power disturbance occurs, a fluctuation range of frequency will expand, and a fluctuation speed thereof will accelerate. It is difficult for the renewable energy to provide reactive power support to the system, the renewable energy is mainly connected to a low-voltage level grid, and voltage regulation ability of the system is significantly reduced after the large-scale connection, which have put forward the requirements of higher adaptability on the DC transmission system. There is an urgent need to develop new commutation technologies to adapt to future Alternating Current (AC) systems.

### SUMMARY

With respect to the above problems, a purpose of embodiments of the disclosure is to provide an SLCC commutation system for a new power system and a method for controlling the SLCC commutation system, which overcomes the problem of high dependence on the AC system in a conventional line-commutated converter (LCC) DC transmission technology and poor adaptability in a large-scale renewable energy convergence scenario, effectively suppresses overvoltage at the sending side and low voltage at the receiving side, and reduces a risk of commutation failure.

In order to achieve the above purpose, the embodiments of the disclosure propose the following technical solutions. An SLCC commutation system for a new power system, includes a converter transformer configured to provide an AC voltage and a converter unit configured for AC-DC conversion. The converter transformer is connected in series to each phase of the converter unit through an inductor, each phase includes a respective upper bridge arm and a respective lower bridge arm, and each of the upper bridge arm and the lower bridge arm includes a respective Voltage Source Converter (VSC) valve. A Static Var Generator (SVG) branch is connected between the converter transformer and the converter unit, the SVG branch is connected in parallel with a LCC converter valve. The SVG branch includes a converter transformer and a reactor connected in series and is configured to adopt a three-phase star connection, and an output end of the reactor is connected to the converter transformer and the converter unit.

In some embodiments, an equivalent model of the SLCC commutation system may include a main circuit and the SVG branch. The main circuit includes an AC signal source and a converter transformer equivalent impedance. The AC signal source is connected in series to the converter transformer equivalent impedance, and an output end of the converter transformer equivalent impedance is connected to the LCC converter valve. The SVG branch includes a second AC signal source and a connected reactor inductance. The second AC signal source is connected in series to the connected reactor inductance, and an output end of the connected reactor inductance is connected to the main circuit.

In some embodiments, the LCC converter valve may be configured to undertake transmission of active power, the SVG branch is configured to provide reactive power, and reactive power exchange of the system returning to zero is used as a control target.

An embodiment of the disclosure further provides a method for controlling an SLCC commutation system for a new power system, the method is configured to conduct a research on the SLCC commutation system as described in any one of the above paragraphs, and includes the following operations. A steady-state characteristics research is conducted on the SLCC commutation system, and a steady-state characteristics research result is obtained. A transient characteristics research is conducted on the SLCC commutation system, and a transient characteristics research result is obtained. A step characteristics research is conducted on the SLCC commutation system, and a step characteristics research result is obtained. The research is conducted on the SLCC commutation system according to the steady-state characteristics research result, the transient characteristics research result and the step characteristics research result.

In some embodiments, a method for controlling a VSC valve in the steady-state characteristics may include: controlling a fundamental frequency current; controlling a harmonic current; combining the fundamental frequency current with the harmonic current, and outputting a combination result; and integrating the combination result with a voltage feedforward result, and obtaining a control voltage of the VSC valve to control the VSC valve.

In some embodiments, a method for controlling the fundamental frequency current [0013] may include: inputting a reactive power command of the system into a reactive current regulator for adjustment, inputting an AC system voltage into a transient reactive power controller for control, performing transient switching between the reactive current regulator and the transient reactive power controller to output a reactive current target value; inputting a sub-module rated capacitor voltage value and a sub-module measured capacitor voltage value into a sub-module capacitor voltage controller, and outputting an active current target value; inputting the AC system voltage into a phase-locked loop (PLL) to generate a system voltage phase; and combining the reactive current target value with the active current target value, and inputting a combination result into a fundamental frequency current controller to generate a fundamental frequency current control result according to the system voltage phase and current at an SVG valve side.

In some embodiments, a method for controlling the harmonic current may include: inputting a converter valve current into a harmonic current detection unit, and outputting a harmonic current target value; and inputting the harmonic current target value and current at an SVG valve side into a harmonic current control unit to generate a harmonic current control result.

In some embodiments, a strategy for locking a VSC valve in the transient characteristics may include: temporarily locking overcurrent in response to detecting that an instantaneous current value of a bridge arm of the VSC valve exceeds a preset value; locking a converter valve in response to a number of temporary locking actions continuously triggered in a preset time exceeding a threshold when a permanent fault occurs; performing overvoltage protection of an average value of a sub-module capacitor of the bridge arm of the VSC valve and locking the converter valve in response to detecting that an average capacitor voltage value of any bridge arm exceeding a threshold; and during operation of the converter valve, in response to a fault occurred to a power module, sending, by a control board of the power module, a bypass request, and determining, by a valve-control controller, whether a sum of a number of sub-modules that have been bypassed in any bridge arm and a number of sub-modules that currently request to be bypassed is greater than a set protection value, and locking the converter valve in response to the sum being greater than the set protection value. A strategy for controlling fault ride-through (FRT) of the VSC valve may include: after the VSC valve detects a voltage drop on an Alternating Current (AC) bus, turning off a harmonic compensation function and outputting a maximum current according to a rated capacity; and resuming the harmonic compensation function and a reactive power command after voltage of the AC bus recovers.

In some embodiments, the VSC valve may have three states: 1) an LCC is normal, and a VSC converter valve is subject to the FRT; 2) the LCC is locked and restarted, and the VSC converter valve is temporarily locked; 3) the LCC is locked and the VSC converter valve is locked, and locking conditions of the LCC converter valve are consistent in fault conditions of SLCC-High Voltage Direct Current (HVDC) and LCC-HVDC.

An embodiment of the disclosure further provides a computer-readable storage medium having stored thereon a computer program that is configured to be executed by a processor to implement the method for controlling the SLCC commutation system for the new power system as described in any one of the above paragraphs.

An embodiment of the disclosure further provides a computer program product, which includes computer readable codes. The computer program product includes a computer program or instruction, and when the computer program or instruction is executed on an electronic device, the method for controlling the SLCC commutation system for the new power system as described in any one of the above paragraphs is performed by the system.

The above technical solutions of the disclosure have the following advantages.
1. The embodiments of the disclosure utilize the voltage source characteristics to reduce the dependence on the AC system, improve the dynamic reactive power characteristics, flexibly adapt to the feed in of the renewable energy islands, and reduce the risk of the commutation failure. At the same time, the harmonic pollution of an AC grid is reduced; the stresses of devices are significantly reduced, and the reliability of safe operation of the devices is improved.
2. The embodiments of the disclosure use mature large-capacity power electronic devices, which have high reliability, low loss and unlimited capacity scale.
3. By means of the coordinated control of the voltage source and the current source, the embodiments of the disclosure effectively reduce a risk of oscillation caused by a single voltage source converter.
4. The embodiments of the disclosure implement self-compensation of harmonics and reactive power, removes the configuration of a large number of filters, greatly reduces an area occupied by the converter station, and improves the environmental adaptability. The technology greatly improves flexibility and adaptability of the DC transmission technology in a scenario where the renewable energy is connected to the grid and sent out by DC in the development situations of future new power systems.

### BRIEF DESCRIPTION OF THE DRAWINGS

In order to explain the technical solutions of the embodiments of the disclosure more clearly, drawings required to be used in the embodiments of the disclosure would be described below.

The drawings here are incorporated into the description and constitute a part of the description. These drawings show embodiments consistent with the disclosure, and are intended to explain the technical solutions of the disclosure together with the description.

FIG. 1 is a schematic structural diagram of an SLCC commutation converter valve in an embodiment of the disclosure.

FIG. 2 is an equivalent diagram of an SLCC-HVDC steady-state circuit in an embodiment of the disclosure.

FIG. 3 is an operating principle diagram of an SLCC converter valve in an embodiment of the disclosure.

FIG. 4 is a control block diagram of a VSC converter valve in an SLCC technology in an embodiment of the disclosure.

FIG. 5A is an optional parameter waveform diagram in an embodiment of the disclosure.

FIG. 5B is an optional parameter waveform diagram in an embodiment of the disclosure.

FIG. 5C is an optional parameter waveform diagram in an embodiment of the disclosure.

FIG. 6A is a waveform diagram of a current at a Y-D converter transformer valve side of an optional conventional LCC technology in an embodiment of the disclosure.

FIG. 6B is a waveform diagram of a current at a Y-Y converter transformer valve side of an optional conventional LCC technology in an embodiment of the disclosure.

FIG. 6C is a waveform diagram of a current at a Y-D converter transformer valve side of an optional SLCC technology in an embodiment of the disclosure.

FIG. 6D is a waveform diagram of a current at a Y-Y converter transformer valve side of an optional SLCC technology in an embodiment of the disclosure.

FIG. 7 is a schematic structural diagram of a control device of an optional SLCC commutation system for a new power system in an embodiment of the disclosure.

### DETAILED DESCRIPTION

In order to enable those skilled in the art to better understand the technical solutions of the disclosure, the disclosure is described in detail through specific embodiments. However, it should be understood that the specific embodiments are only provided for the purpose of understanding the disclosure better, and they should not be understood as limitations of the disclosure. In descriptions of the disclosure, it should be understood that terms used are only for the purpose of description, and cannot be understood as indicating or implying relative importance.

In the related art, since the randomness and volatility of wind power and photovoltaic power generation cause uncertainty of output at a power supply side, and a system inertia provided by the wind turbines is much smaller than that provided by thermal power units, once the active power disturbance occurs in the new power system, a fluctuation range of the frequency will expand, and a fluctuation speed thereof will accelerate. In this way, it is difficult for the renewable energy to provide reactive power support to the system. In addition, the renewable energy is mainly connected to a low-voltage level grid, therefore, with the large-scale connection a voltage regulation ability of the system is significantly reduced. The disclosure provides a Statcom and Line Commutation Converter (SLCC) commutation system for a new power system and a method for controlling the SLCC commutation system, which overcomes a series of technical defects of a conventional line-commutated converter (LCC) Direct Current (DC) transmission technology, reduces dependence on an Alternating Current (AC) system, improves adaptability in a large-scale renewable energy convergence scenario, effectively suppresses a problem of overvoltage at a sending side and low voltage at a receiving side, and reduces a risk of commutation failure. Furthermore, the quality pollution and oscillation of electric energy caused by harmonics flowing into the AC system may be reduced, and the device safety risk caused by frequent actions of a Load Tap Changer (LTC) and repeated switching of a filter may be significantly reduced. Meanwhile, the embodiments of the disclosure may reduce a limited extent of the capacity of a Voltage Source Converter (VSC) DC transmission technology, reduce a risk of oscillation, improve the reliability, reduce the losses, and may be an upgrade technology of the conventional DC transmission technology in the development conditions of the future new power system.

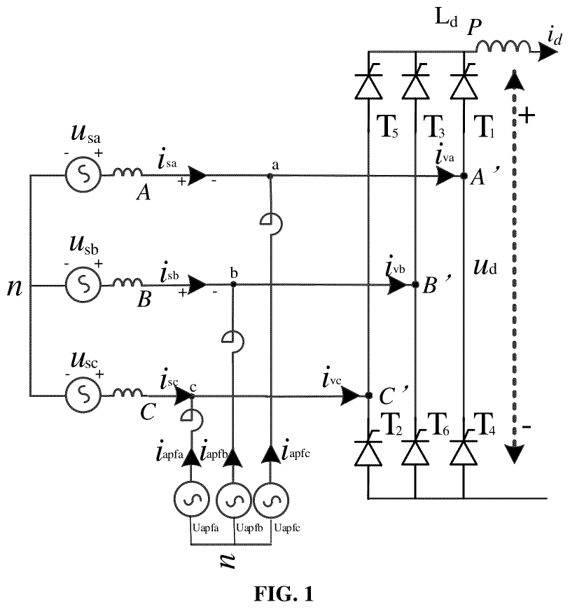

An embodiment of the disclosure provides an SLCC commutation system for a new power system, and the main features thereof lie in that a Static Var Generator (SVG) device is connected in parallel at a converter transformer valve side of a 6-pulse thyristor converter. An LCC converter valve is configured to undertake transmission of active power. An SVG branch provides reactive power, and adopts a three-phase star connection and a structure where a neutral point is not grounded. Reactive power exchange of the system returning to zero is used as a control target. As shown in FIG. 1, the system includes a converter transformer configured to provide an AC voltage and a converter unit configured for AC-DC conversion. The converter transformer is connected in series to each phase of the converter unit through an inductor. Each phase includes a respective upper bridge arm and a respective lower bridge arm, and each of the upper bridge arm and the lower bridge arm includes a respective VSC valve. An SVG branch is connected between the converter transformer and the converter unit and is connected in parallel with an LCC converter valve. The SVG branch includes a converter transformer and a reactor connected in series and adopts a three-phase star connection. An output end of the reactor is connected to the converter transformer and the converter unit.

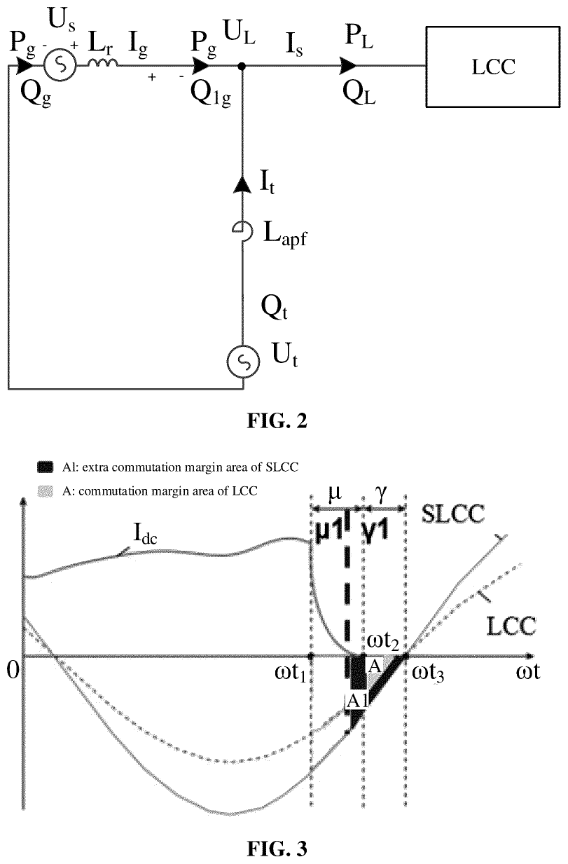

As shown in FIG. 2, an equivalent model of the SLCC commutation system includes a main circuit and an SVG branch, the main circuit includes an AC signal source and a converter transformer equivalent impedance. The AC signal source is connected in series to the converter transformer equivalent impedance, and an output end of the converter transformer equivalent impedance is connected to the LCC converter valve. The SVG branch includes a second AC signal source and a connected reactor inductance. The second AC signal source is connected in series to the connected reactor inductance, and an output end of the connected reactor inductance is connected to the main circuit. Uₛ is a voltage of the converter transformer, I_{g} is a line current of an outlet of the converter transformer, and Lᵣ is the converter transformer equivalent impedance. Pₛ and Qₛ are active power and reactive power of the transmission of the AC system respectively. UL is an AC voltage at a grid connection point, and P_{g} and Q_{lg} are active power and reactive power of the transmission at the grid connection point respectively. Iₛ is a line current at an outlet valve side of the converter transformer, and P_{L} and Q_{L} are active power and reactive power of the transmission at an LCC valve side respectively. L_{apf} is a connected reactor of the SVG branch. Iₜ is a current of the SVG branch. Ut is an SVG equivalent voltage source. Qₜ is output reactive power of the SVG.

Compared to a conventional LCC system, the SLCC system is provided with an extra SVG branch. After a converter transformer impedance is connected in parallel with an SVG impedance, a value of a combined resistance of is reduced, which reduces an inductive voltage drop, accelerates a commutation process, and reduces reactive power consumption of the converter valve and a number of actions of a tap changer in a steady state.

When a fault condition occurs, with respect to an LCC-High Voltage Direct Current (HVDC) system, commutation failure is mainly caused by an AC fault occurred at an inverter side, a voltage drop on an AC bus, an AC current fed into a DC side, and an insufficient commutation margin of the converter. An SLCC-HVDC system provides an auxiliary commutation voltage to the system by controlling on and off of the VSC valve, thereby accelerating a commutation process of the DC system and improving a commutation margin of the system. A specific process of the fault is shown in FIG. 3, in which the dark dotted line represents a commutation voltage of a conventional LCC technology, and the light solid line represents a commutation voltage of the SLCC system. Since the SLCC system has an ability of supporting the commutation voltage, the SLCC system may complete the commutation faster under a premise of the same commutation area, which further increases a margin of a turn-off angle and reduces the risk of commutation failure.

Based on the same inventive concept, an embodiment of the disclosure provides a method for controlling an SLCC commutation system for a new power system. The method is configured to conduct a research on the SLCC commutation system as described in any one of the above paragraphs, and includes the following operations S1 to S4.

In operation S1, a steady-state characteristics research is conducted on the SLCC commutation system to obtain a steady-state characteristics research result.

In operation S2, a transient characteristics research is conducted on the SLCC commutation system to obtain a transient characteristics research result.

In operation S3, a step characteristics research is conducted on the SLCC commutation system to obtain a step characteristics research result.

In operation S4, the research is conducted on the SLCC commutation system according to the steady-state characteristics research result, the transient characteristics research result and the step characteristics research result.

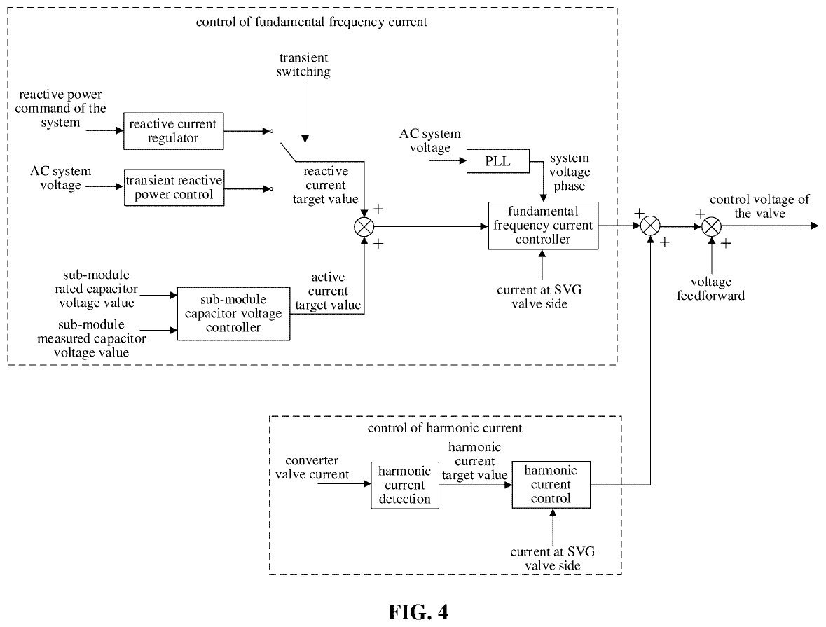

First, an SLCC-HVDC transmission model is established based on a PSCAD/EMTDC simulation software. In the model, the SLCC system adopts separate control for the active power and the reactive power, and the LCC converter valve is configured to undertake the transmission of the active power. The SVG branch provides the reactive power and performs dynamic reactive power control as well as filtering. A reactive power control target is set as the reactive power of the AC system returning to zero for the first time, and a harmonic control target is the harmonic at the valve side returning to zero. A specific control block diagram is shown in FIG. 4 below. In the SLCC-HVDC system, an LCC sending side adopts the constant current/constant power control, and an LCC receiving side uses constant voltage/fixed angle control.

As shown in FIG. 4, a method for controlling a VSC valve in the steady-state characteristics includes the following operations S1.1 to S1.4.

In operation S1.1, a fundamental frequency current is controlled.

A method for controlling the fundamental frequency current may include: inputting a reactive power command of the system into a reactive current regulator for adjustment, inputting an AC system voltage into a transient reactive power controller for control, performing transient switching between the reactive current regulator and the transient reactive power controller to output a reactive current target value; inputting a sub-module rated capacitor voltage value and a sub-module measured capacitor voltage value into a sub-module capacitor voltage controller, and outputting an active current target value; inputting the AC system voltage into a phase-locked loop (PLL) to generate a system voltage phase; and combining the reactive current target value with the active current target value, and inputting a combination result into a fundamental frequency current controller to generate a fundamental frequency current control result according to the system voltage phase and current at an SVG valve side.

In operation S1.2, a harmonic current is controlled.

A method for controlling the harmonic current includes: inputting a converter valve current into a harmonic current detection unit, and outputting a harmonic current target value; and inputting the harmonic current target value and current at an SVG valve side into a harmonic current control unit to generate a harmonic current control result.

In operation S1.3, the fundamental frequency current is combined with the harmonic current, and a combination result is output.

In operation S1.4, the combination result is integrated with a voltage feedforward result, and a control voltage of the VSC valve is obtained to control the VSC valve.

The steady-state characteristics include reactive power compensation characteristics and harmonic compensation characteristics.

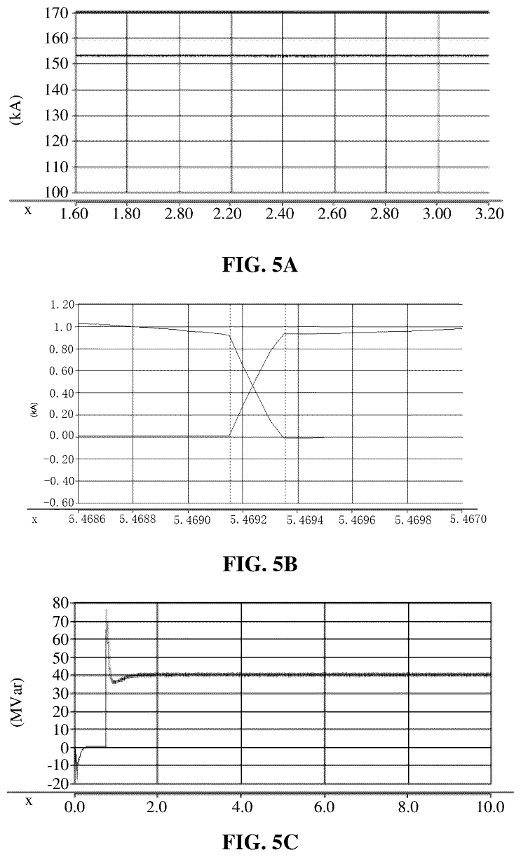

FIG. 5A to FIG. 5C are various parameter waveform diagrams with a DC power of 0.1 pu in an embodiment of the disclosure. In FIG. 5A, Vt=152.67 kV. In FIG. 5B, μ=1.8°. In FIG. 5C, Qc=−40 Mvar. Reactive power output parameters of the VSC converter valve in a process of the DC power increasing and decreasing from a power of 0.1 to 1.0 pu are observed through FIG. 5A to FIG. 5C. Main branch parameters of the equivalent model of the SLCC commutation system are shown in Table 1.

TABLE 1
Main circuit parameter result table

| | | | | QVSC converter |
|---|---|---|---|---|
| P/p.u. | I/kA | α/° | μ/° | valve/Mvar |
| 0.1 | 0.5 | 15 | 1.8 | 40 |
| 0.2 | 1.0 | 15 | 3.6 | 69 |
| 0.3 | 1.5 | 15 | 5.4 | 103 |
| 0.4 | 2.0 | 15 | 7.2 | 130 |
| 0.5 | 2.5 | 15 | 9.0 | 180 |
| 0.6 | 3.0 | 15 | 10.8 | 226 |
| 0.7 | 3.5 | 15 | 12.6 | 275 |
| 0.8 | 4.00 | 15 | 14.4 | 315 |
| 0.9 | 4.5 | 15 | 16.2 | 380 |
| 1 | 5.0 | 15 | 18 | 440 |

In case that a DC current is 5 kA, reactive power output at a port of the VSC converter valve is 440 Mvar, which is within a designed fundamental capacity range of the VSC converter valve. A reactive power configuration capacity of a conventional LCC is usually 60% of the DC power, and is about 4800 Mvar considering a set to be reserved. Considering various tough operation conditions, reactive power consumption of the entire station in the SLCC technical solution is 490×8=3920 MVA. Compared to the conventional LCC solution, reactive power consumption of a single converter station may be reduced by 880 MVA as a whole.

Since the VSC converter valve uses a current source control mode to compensate current of the converter valve, a compensation effect thereof depends on a measurement accuracy of the current of the converter valve. If the measurement is very accurate, a compensation degree may be close to 100%. Considering an error occurred in the measurement of the harmonic current as well as the uncertainty of the delay, the compensation effect of the VSC converter valve may be reduced. In the simulation, the SVG is set to compensate 6k+1 harmonics by 49 times, and a short-circuit ratio (SCR) of the system is set as SCR=3. After the SVG compensates the harmonics, a harmonic current component flowing into the AC system is very small, a compensation rate reaches over 98%, and the harmonic voltage meets the design requirements.

TABLE 2
Harmonic compensation effect table

| | Effective value of | Effective value of | Distortion rate of |
|---|---|---|---|
| Times of | harmonic current of the | harmonic current of | harmonic voltage of |
| harmonics | converter value (A) | the grid (A) | the grid |
| 5 times | 760.0 | 1.4 | 0.12 |
| 7 times | 531.2 | 0.3 | 0.06 |
| 11 times | 320.3 | 0.5 | 0.02 |
| 13 times | 238.6 | 0.5 | 0.07 |
| 23 times | 92.8 | 1.4 | 0.05 |
| 25 times | 75.2 | 1.4 | 0.06 |
| 35 times | 29.0 | 5.3 | 0.43 |
| 37 times | 23.9 | 4.3 | 0.58 |
| 47 times | 33.7 | 0.6 | 0.06 |
| 49 times | 29.8 | 0.4 | 0.02 |

| | |
|---|---|
| THDu in total | 1.3% |

Transient characteristics: a PSCAD transient simulation research is conducted on the SLCC-HVDC. The following contents are simulated and verified in PSCAD. A strategy for locking a VSC valve in the transient characteristics includes the following operations.

When it is detected that an instantaneous current value of a bridge arm of the VSC valve exceeds 5 kA, there is a delay of 10 us and the overcurrent is temporarily locked. When it is detected that the current of the bridge arm instantaneously drops below 3000A, there is a delay of 5 ms and the converter valve is unlocked.

A temporary locking action may occur multiple times when a permanent fault occurs to the system, resulting in continuous and frequent switching and thus damaging the device. When the temporary locking action continuously is triggered three times in 1s, the converter valve is locked.

When it is detected that an average capacitor voltage value of any bridge arm exceeding 3100V, there is a delay of 200 us, overvoltage protection of an average value of a sub-module capacitor of the bridge arm of the VSC valve is performed and the converter valve is locked.

During operation of the converter valve, in response to a fault occurred to a power module, a control board of the power module sends a bypass request to the valve-control controller, and a valve-control controller determines whether a sum of a number of sub-modules that have been bypassed in any bridge arm and a number of sub-modules that currently request to be bypassed is greater than a set protection value. The converter valve is locked in response to the sum being greater than the set protection value.

A strategy for controlling fault ride-through (FRT) the VSC valve includes: after the VSC valve detects a voltage drop on an AC bus of 500 kV, a harmonic compensation function is turned off and a maximum current is output according to a rated capacity. After the voltage of the AC bus recovers, the harmonic compensation function and a reactive power command are resumed.

A conclusion of transient characteristics test items is shown in Table 3. The VSC valve has three states: 1) an LCC is normal, and a VSC converter valve is subject to the FRT; 2) the LCC is locked and restarted, and the VSC converter valve is temporarily locked; 3) the LCC is locked and the VSC converter valve is locked, and locking conditions of the LCC converter valve are consistent in fault conditions of SLCC-High Voltage Direct Current (HVDC) and LCC-HVDC.

TABLE 3
Transient characteristics test item table

| | | | SLCC-HVDC | |
|---|---|---|---|---|
| Serial | | LCC-HVDC | | LLC |
| Number | | LCC converter | VSC converter | converter |
| (SN) | Test item | valve | valve | valve |

Fault of an AC system at a rectification side

| | | | | |
|---|---|---|---|---|
| 1 | Power is 1.0 pu, and single- | Unlock, and | Unlock, subject | Unlock, and |
| | phase grounding fault of an | recover after the | to FRT, and | recover after |
| | AC bus at the rectification | fault | reactive power | the fault |
| | side lasts 100 ms | | is output to 0 | |
| | | | during fault | |

Fault at a valve side

| | | | | |
|---|---|---|---|---|
| 2 | Power is 1.0 pu, inter-phase | LCC converter | VSC converter | LCC |
| | fault occurs at the | valve is phase | valve is locked | converter |
| | converter valve side of the | shifted and | | valve is phase |
| | high end of pole 1 | locked | | shifted and |
| | | | | locked |

Fault of DC line

| | | | | |
|---|---|---|---|---|
| 3 | Power is 1.0 pu, inter- | LCC valve is | VSC converter | LCC valve is |
| | station communication is | phase shifted and | valve is | phase shifted |
| | normal, and fault at a | restarted during | temporarily | and restarted |
| | midpoint of a 800 kV DC | the fault | locked | during the |
| | line lasts 100 ms | | | fault |

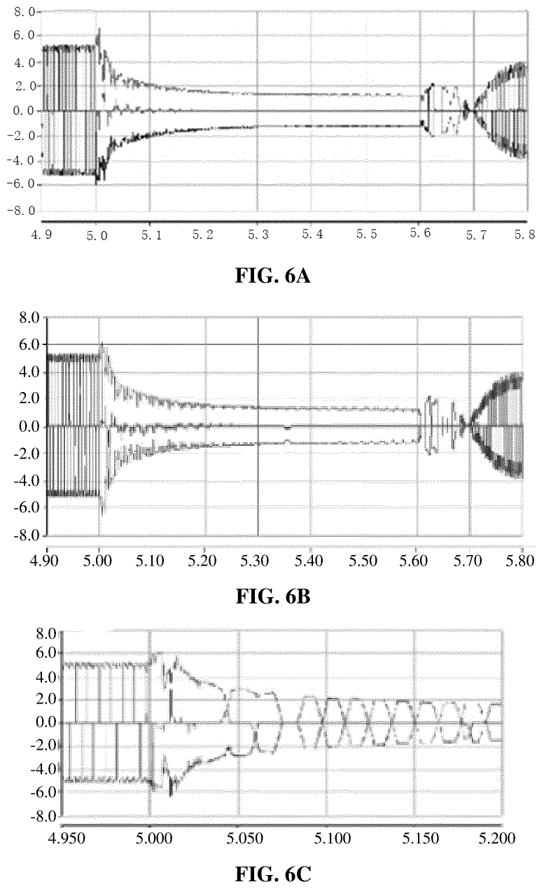

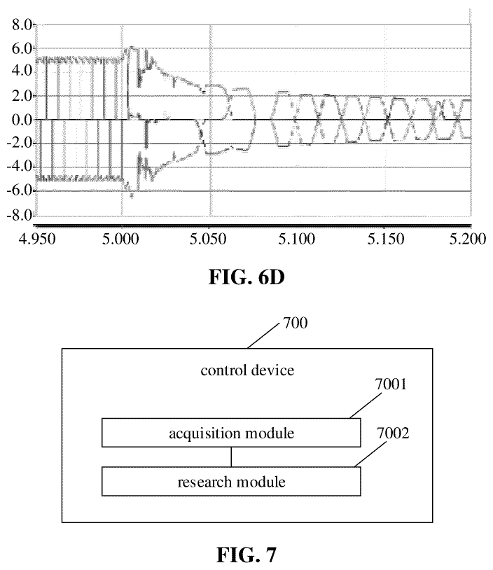

Meanwhile, in the transient operation conditions, the SLCC technology has an ability of supporting the commutation voltage, which may reduce a probability of commutation failure and improve a recovery speed of the DC system. FIG. 6A is a waveform diagram of a current at a Y-D converter transformer valve side of a conventional LCC technology. FIG. 6B is a waveform diagram of a current at a Y-Y converter transformer valve side of a conventional LCC technology. FIG. 6C is a waveform diagram of a current at a Y-D converter transformer valve side of an SLCC technology. FIG. 6D is a waveform diagram of a current at a Y-Y converter transformer valve side of an SLCC technology. A metallic short-circuit fault occurs to an AC system at an inverter side of the LCC, commutation of the LCC fails, and the SLCC may output current according to the maximum capacity during the fault, which accelerates a recovery process of the LCC converter valve.

In the embodiment of the disclosure, step characteristics tests such as the current step, the power step, the DC voltage step, the turn-off angle step or the like in 0.5 pu are conducted in sequence based on the PSCAD simulation model. The test parameters are as shown in Table 4, and the test conclusion is the same as the expected effect of the LCC-HVDC.

TABLE 4
Step characteristics test parameter table

| | | Steady-state | Time to reach | Steady-state | Overshoot |
|---|---|---|---|---|---|
| Item | Step value | value | 90% (ms) | value after step | value (%) |

Current step

| | | | | | | | | |
|---|---|---|---|---|---|---|---|---|
| Up step | 2500 | A | 2508 | A | 117 | 4979 | A | 7.6 |
| Down step | 2500 | A | 4979 | A | 92 | 2573 | A | 10.1 |

Power step

| | | | | | | | | |
|---|---|---|---|---|---|---|---|---|
| Up step | 2000 | MW | 2002 | MW | 129 | 3969 | MW | 0 |
| Down step | 2000 | MW | 3995 | MW | 41 | 2022 | MW | 37.6 |

Voltage step

| | | | | | | | | |
|---|---|---|---|---|---|---|---|---|
| Up step | 80 | kV | 797 | kV | 77 | 717 | kV | 36 |
| Down step | 80 | kV | 717 | kV | 90 | 797 | kV | 15 |

Turn-off angle step

| | | | | | |
|---|---|---|---|---|---|
| Up step | 10° | 20° | — | 27.2° | 0 |
| Down step | 10° | 27.2° | — | 20° | 0 |

Based on the same inventive concept, an embodiment of the disclosure provides a control device of the SLCC commutation system for a new power system. As shown in FIG. 7, the control device 700 includes an acquisition module 7001 and a research module 7002.

The acquisition module 7001 is configured to: conduct a steady-state characteristics research on the SLCC commutation system to obtain a steady-state characteristics research result; conduct a transient characteristics research on the SLCC commutation system to obtain a transient characteristics research result; and conduct a step characteristics research on the SLCC commutation system to obtain a step characteristics research result.

The research module 7002 is configured to conduct the research on the SLCC commutation system according to the steady-state characteristics research result, the transient characteristics research result and the step characteristics research result.

In some embodiments, the acquisition module 7001 is further configured to: control a fundamental frequency current; control a harmonic current; combine the fundamental frequency current with the harmonic current, and output a combination result; and integrate the combination result with a voltage feedforward result, and obtain a control voltage of the VSC valve to control the VSC valve.

In some embodiments, the acquisition module 7001 is further configured to: input a reactive power command of the system into a reactive current regulator for adjustment, input an AC system voltage into a transient reactive power controller for control, perform transient switching between the reactive current regulator and the transient reactive power controller to output a reactive current target value; input a sub-module rated capacitor voltage value and a sub-module measured capacitor voltage value into a sub-module capacitor voltage controller, and output an active current target value; input the AC system voltage into a PLL to generate a system voltage phase; and combine the reactive current target value with the active current target value, and input a combination result into a fundamental frequency current controller to generate a fundamental frequency current control result according to the system voltage phase and current at an SVG valve side.

In some embodiments, the acquisition module 7001 is further configured to: input a converter valve current into a harmonic current detection unit, and output a harmonic current target value; and input the harmonic current target value and current at an SVG valve side into a harmonic current control unit to generate a harmonic current control result.

In some embodiments, the acquisition module 7001 is further configured to: temporarily lock overcurrent in response to detecting that an instantaneous current value of a bridge arm of the VSC valve exceeds a preset value; lock a converter valve in response to a number of temporary locking actions continuously triggered in a preset time exceeding a threshold when a permanent fault occurs; perform overvoltage protection of an average value of a sub-module capacitor of the bridge arm of the VSC valve and lock the converter valve in response to detecting that an average capacitor voltage value of any bridge arm exceeding a threshold; and during operation of the converter valve, in response to a fault occurred to a power module, send, by a control board of the power module, a bypass request, and determine, by a valve-control controller, whether a sum of a number of sub-modules that have been bypassed in any bridge arm and a number of sub-modules that currently request to be bypassed is greater than a set protection value, and lock the converter valve in response to the sum being greater than the set protection value. A strategy for controlling FRT of the VSC valve includes: after the VSC valve detects a voltage drop on an AC bus, turning off a harmonic compensation function and outputting a maximum current according to a rated capacity; and resuming the harmonic compensation function and a reactive power command after voltage of the AC bus recovers.

In some embodiments, the VSC valve has three states: 1) an LCC is normal, and a VSC converter valve is subject to the FRT; 2) the LCC is locked and restarted, and the VSC converter valve is temporarily locked; 3) the LCC is locked and the VSC converter valve is locked, and locking conditions of the LCC converter valve are consistent in fault conditions of SLCC-High Voltage Direct Current (HVDC) and LCC-HVDC.

Based on the same invention concept, an embodiment of the disclosure provides a computer-readable storage medium. The computer-readable storage medium has stored thereon a computer program. The computer program is executed by a processor to implement the method for controlling the SLCC commutation system for a new power system as described in any one of the above paragraphs.

It should be appreciated by those skilled in the art that the embodiments of the disclosure may be provided as a method, a system or a computer program product. Therefore, the present disclosure may take a form of an entire hardware embodiment, an entire software embodiment, or an embodiment combining software and hardware aspects. Furthermore, the disclosure may take a form of a computer program product embodied on one or more computer-usable storage media (including, but not limited to a disk memory, a Compact Disk Read Only Memory (CD-ROM), an optical memory, etc.) where computer-usable program codes are contained.

The disclosure is described with reference to flowcharts and/or block diagrams of the method, device (system) and computer program product according to the embodiments of the disclosure. It should be understood that each process and/or block in the flowchart and/or the block diagram, and a combination of processes and/or blocks in the flowchart and/or the block diagram may be implemented by computer program instructions. These computer program instructions may be provided to a processor of a general purpose computer, a dedicated computer, an embedded processor or other programmable data processing devices to produce a machine, such that instructions executed by the processor of the computer or other programmable data processing devices generate a device configured to implement functions specified in one or more processes of the flowchart and/or one or more blocks of the block diagram.

These computer program instructions may also be stored in a computer-readable memory that may guide the computer or other programmable data processing devices to operate in a specific manner, such that instructions stored in the computer-readable memory generate an article of manufacture including an instruction apparatus, and the instruction apparatus implements functions specified in one or more processes of the flowchart and/or one or more blocks of the block diagram.

These computer program instructions may also be loaded onto the computer or other programmable data processing devices, such that a series of operational steps are performed on the computer or other programmable devices to generate computer-implemented processes, and thus instructions executed on the computer or other programmable devices provide operations configured to implement functions specified in one or more processes of the flowchart and/or one or more blocks of the block diagram.

Finally, it should be noted that the foregoing embodiments are for illustrative purposes only and are not intended to limit the technical solutions of the disclosure. Although the disclosure has been described in detail with reference to the above embodiments, it should be understood by those of ordinary skill in the art that modifications or equivalent replacements may still be made to specific implementations of the disclosure, and any modification or equivalent replacement that do not depart from the spirit and scope of the disclosure shall fall within the scope of protection of claims of the disclosure. The above contents are only specific implementations of the disclosure. However, the scope of protection of the disclosure is not limited thereto. Variation or replacement easily conceived by any technician familiar with this technical field within the technical scope disclosed in the disclosure shall fall within the scope of protection of the disclosure. Therefore, the scope of protection of the disclosure should be subject to the scope of protection of the claims.

### INDUSTRIAL APPLICABILITY

In the embodiments of the disclosure, voltage source characteristics are utilized to reduce dependence on the AC system in the conventional LCC DC transmission technology, and improve adaptability in a large-scale renewable energy convergence scenario. Configuration of the filter is minimized, thereby reducing an area occupied by the converter station. A risk of oscillation caused by a converter having a single voltage source is reduced through coordinated control of the voltage source and the current source.

1. A Statcom and Line Commutation Converter (SLCC) commutation system for a new power system, comprising a first converter transformer configured to provide an Alternating Current (AC) voltage and a converter unit configured for AC-Direct Current (DC) conversion,
wherein the first converter transformer is connected in series to each phase of the converter unit through an inductor, each phase comprises a respective upper bridge arm and a respective lower bridge arm, and each of the upper bridge arm and the lower bridge arm comprises a respective Voltage Source Converter (VSC) valve, wherein a Static Var Generator (SVG) branch is connected between the first converter transformer and the converter unit, the SVG branch is connected in parallel with a line-commutated converter (LCC) converter valve, the SVG branch comprises a second converter transformer and a reactor connected in series and is configured to adopt a three-phase star connection, and an output end of the reactor is connected to the first converter transformer and the converter unit.

2. The SLCC commutation system for the new power system of claim 1, wherein an equivalent model of the SLCC commutation system comprises a main circuit and the SVG branch, the main circuit comprises an AC signal source and a converter transformer equivalent impedance, the AC signal source is connected in series to the converter transformer equivalent impedance, and an output end of the converter transformer equivalent impedance is connected to the LCC converter valve; wherein the SVG branch comprises a second AC signal source and a connected reactor inductance, the second AC signal source is connected in series to the connected reactor inductance, and an output end of the connected reactor inductance is connected to the main circuit.

3. The SLCC commutation system for the new power system of claim 1, wherein the LCC converter valve is configured to undertake transmission of active power, the SVG branch is configured to provide reactive power, and reactive power exchange of the system returning to zero is used as a control target.

4. A method for controlling a Statcom and Line Commutation Converter (SLCC) commutation system for a new power system, configured to conduct a research on the SLCC commutation system of claim 1, comprising:
conducting a steady-state characteristics research on the SLCC commutation system to obtain a steady-state characteristics research result;
conducting a transient characteristics research on the SLCC commutation system to obtain a transient characteristics research result;
conducting a step characteristics research on the SLCC commutation system to obtain a step characteristics research result; and
conducting the research on the SLCC commutation system according to the steady-state characteristics research result, the transient characteristics research result and the step characteristics research result.

5. The method for controlling the SLCC commutation system for the new power system of claim 4, wherein a method for controlling a Voltage Source Converter (VSC) valve in the steady-state characteristics comprises:
controlling a fundamental frequency current;
controlling a harmonic current;
combining the fundamental frequency current with the harmonic current, and outputting a first combination result; and
integrating the first combination result with a voltage feedforward result, and obtaining a control voltage of the VSC valve to control the VSC valve.

6. The method for controlling the SLCC commutation system for the new power system of claim 5, wherein a method for controlling the fundamental frequency current comprises:
inputting a reactive power command of the system into a reactive current regulator for adjustment, inputting an Alternating Current (AC) system voltage into a transient reactive power controller for control, performing transient switching between the reactive current regulator and the transient reactive power controller to output a reactive current target value;
inputting a sub-module rated capacitor voltage value and a sub-module measured capacitor voltage value into a sub-module capacitor voltage controller, and outputting an active current target value;
inputting the AC system voltage into a phase-locked loop (PLL) to generate a system voltage phase; and
combining the reactive current target value with the active current target value, and inputting a second combination result into a fundamental frequency current controller to generate a fundamental frequency current control result according to the system voltage phase and current at a Static Var Generator (SVG) valve side.

7. The method for controlling the SLCC commutation system for the new power system of claim 5, wherein a method for controlling the harmonic current comprises:
inputting a converter valve current into a harmonic current detection unit, and outputting a harmonic current target value; and
inputting the harmonic current target value and current at a Static Var Generator (SVG) valve side into a harmonic current control unit to generate a harmonic current control result.

8. The method for controlling the SLCC commutation system for the new power system of claim 4, wherein a strategy for locking a Voltage Source Converter (VSC) valve in transient characteristics comprises:
temporarily locking overcurrent in response to detecting that an instantaneous current value of a bridge arm of the VSC valve exceeds a preset value;
locking a converter valve in response to a number of temporary locking actions continuously triggered in a preset time exceeding a threshold when a permanent fault occurs;
performing overvoltage protection of an average value of a sub-module capacitor of the bridge arm of the VSC valve and locking the converter valve in response to detecting that an average capacitor voltage value of any bridge arm exceeding a threshold; and
during operation of the converter valve, in response to a fault occurred to a power module, sending, by a control board of the power module, a bypass request, and determining, by a valve-control controller, whether a sum of a number of sub-modules that have been bypassed in any bridge arm and a number of sub-modules that currently request to be bypassed is greater than a set protection value, and locking the converter valve in response to the sum being greater than the set protection value,
wherein a strategy for controlling fault ride-through (FRT) the VSC valve comprises: after the VSC valve detects a voltage drop on an Alternating Current (AC) bus, turning off a harmonic compensation function and outputting a maximum current according to a rated capacity; and resuming the harmonic compensation function and a reactive power command after voltage of the AC bus recovers.

9. The method for controlling the SLCC commutation system for the new power system of claim 8, wherein the VSC valve has three states: 1) a line-commutated converter (LCC) is normal, and a VSC converter valve is subject to the FRT; 2) the LCC is locked and restarted, and the VSC converter valve is temporarily locked; 3) the LCC is locked and the VSC converter valve is locked, and locking conditions of the LCC converter valve are consistent in fault conditions of SLCC-High Voltage Direct Current (HVDC) and LCC-HVDC.

10. A non-volatile computer-readable storage medium, having stored thereon a computer program that is configured to be executed by a processor to implement the method for controlling the SLCC commutation system for the new power system of claim 4.

11. (canceled)
